(19) United States
(12) Patent Application Publication
(10) Pub. No.: US 2009/0079408 A1
(43) Pub. Date: Mar. 26, 2009

(54) VOLTAGE MODE PWMFF-PFM/SKIP COMBO CONTROLLER

(75) Inventors: Chongming Qiao, Irvine, CA (US); Reza Amirani, Dana Point, CA (US); Vincent Condito, San Jose, CA (US); Amir Asvadi, Laguna Hills, CA (US)

Correspondence Address: Vern Maine & Associates, 100 MAIN STREET, P O BOX 3445, NASHUA, NH, 03061-3445, US

(73) Assignee: NEXEM, INC., Irvine, CA (US)

(21) Appl. No.: 12/107,968

(22) Filed: Apr. 23, 2008

Related U.S. Application Data
(60) Provisional application No. 60/974,160, filed on Sep. 21, 2007.

(51) Int. Cl. G05F 1/46

(52) U.S. Cl. 323/283

(57) ABSTRACT

A voltage controller and method providing multiple modes of operation. Embodiments include pulse-width modulation (PWM), feed-forward (FF), pulse-frequency modulation (PFM) and skip operation (PWM-FF-PFM/SKIP). Controller embodiments have integrated MOSFET components, comparator hysteresis, oscillator feed-forward, fixed gain, and error amplifier (EA) limits thereby providing improved efficiency and noise immunity.

### RELATED APPLICATIONS

This application claims the benefit of U.S. Provisional Application No. 60/974,160 filed Sep. 21, 2007. This application is herein incorporated in its entirety by reference.

### FIELD OF THE INVENTION

The invention relates to voltage regulators and, more specifically, to pulse-width modulation (PWM) feed-forward (FF) pulse-frequency modulation (PFM) PWMFF-PFM/SKIP controller systems and methods.

### BACKGROUND OF THE INVENTION

Electronics components are becoming increasingly complex and miniaturized. Accompanying this progress is decreased power consumption. However, benefits of low power consumption can be lost if the accompanying DC power supplies are inefficient. Efficiencies can be improved through controller design. Voltage mode pulse-width modulation (PWM) controllers have been widely used in the power industry in many applications including in motherboards, VGA cards, DC to DC converters. While suitable for some purposes, these traditional controllers have disadvantages.

Drawbacks of traditional voltage mode PWM controllers include poor response with input voltage response, input voltage dependent system bandwidth, and poor efficiency at light load. Light load efficiency is very important for portable applications since it is directly related to battery life or operating time.

What is needed is a controller that is efficient, especially at low power, provides improved noise immunity, and demonstrates reduced under/overshoot.

### SUMMARY OF THE INVENTION

One embodiment of the present invention provides a voltage mode PWMFF-PFM/SKIP controller system. Embodiments may be employed in both synchronous and non-synchronous buck converters. Embodiments are based on the voltage mode PWM controller. Previous work is based on current mode controllers and current information is needed to operate them correctly. For this invention, no load current information is sensed and a voltage mode PWM scheme is employed instead of a current mode.

An embodiment of a controller has the following features: At heavy load, the controller operates as a fixed frequency voltage-mode PWM controller with feed-forward, improving noise immunity, providing good efficiency from small to high load, and good dynamic response. At light load, the controller switches over to pulse frequency modulation (PFM). A benefit of this controller is that the frequency is linearly dependent on the load, when the load is small, the switching frequency is reduced, significantly improving the efficiency at light load. This makes this controller especially suitable for a portable or notebook applications.

A simple architecture of an oscillator embodiment to provide the feed-forward function is shown in FIG. 4. This architecture allows the oscillation ramp to be proportional to V_{IN} without changing the frequency. It also allows programmable frequency with an external resistor.

In an embodiment of the controller (e.g. FIG. 3), at heavy load, the system operates in voltage mode PWM control, and the error amplifier controls the regulation. At light load, the system will switch to PFM mode. In PFM mode, in an embodiment, a clamp circuit clamps the error amplifier output to a predicted value. This clamped value is very close to the real voltage in the application. This benefit is that the output does not have a big droop when a load suddenly changes from light load to heavy load, when load. When the system changes from light load to heavy load the system will switch back to PWM mode. In other words, in an embodiment, a clamp circuit provides that the system will go back to PWM mode smoothly.

A DC voltage derived from a reference and a resistor divider is used to indicate the output voltage. This will ensure that the controller clamps the error amplifier output to a predicted value in PFM mode.

An embodiment of simple mode selection logic to enable the PWM/PFM switching is shown in FIG. 5. This logic is achieved by sensing the low side MOSFET ON-resistance (RDSON), which is implementable without an extra current sensing element.

To avoid chattering when the system transfers from one mode to the other mode (e.g. PWM to PFM); hysteresis is added, as shown in FIG. 7.

A PWM/SKIP controller embodiment that can work with ceramic output capacitors is also described as shown in FIGS. 23 and 24 and demonstrated in FIG. 25. This embodiment allows the use of ceramic output capacitors which is popular in portable application such as cell phones, etc. The concept is to limit the error amplifier such that the output can not be lower than 70% or some other percentage of predicted value. As a result, at light load, the output will keep increasing and once Vₒᵤₜ is above 3% or some percentage of nominal voltage, the system will shut off and will go into low current mode. The state graph is shown in FIG. 24. This provides high efficiency at light load. The predicted error amplifier output is calculated based on V_{IN} and the desired V_{OUT}. This provides a high efficiency operation over the entire load range and still guarantees output regulation.

An advantage of PWM/SKIP mode is also that the whole controller is controlled by the error amplifier and the skip comparator. At light load, the system operates with a few cycles of PWM operation with fixed frequency. Then, it shuts off and relies on the load to discharge the output. As a result, efficiency is higher. No PFM Comparator is used. This eliminates the sensitivity of PFM control (pulse frequency control) without sacrificing efficiency.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a simplified prior art block diagram illustrating a traditional voltage mode PWM controller for synchronous buck applications.

FIG. 2 is a simplified block diagram illustrating a voltage mode PWMFF_PFM/SKIP combo controller as may be incorporated in a portable application, configured in accordance with one embodiment of the present invention.

FIG. 3 is a block diagram illustrating the PWMFF_PFM combo controller as can be used in FIG. 2, configured in accordance with one embodiment of the present invention.

FIG. 4 is a diagram illustrating an oscillator as can be used in FIG. 3, configured in accordance with one embodiment of the present invention.

FIG. 5 is a simplified block diagram illustrating mode selection logic as can be used in FIG. 3, with add-in hysteresis, configured in accordance with one embodiment of the present invention.

FIG. 6 illustrates a graph of switching frequency versus load current in a model case configured in accordance with one embodiment of the present invention.

FIG. 7 illustrates a graph of switching frequency versus load current for a controller with added hysteresis configured in accordance with one embodiment of the present invention.

FIG. 8 is a block diagram illustrating a controller in an application with monolithic power (integrated controller and metal-oxide-semiconductor field-effect transistors (MOSFETs)), configured in accordance with one embodiment of the present invention.

FIG. 9 illustrates a graphical depiction of DC operation of the controller of FIG. 3 at a 10 amp load in pulse width modulation (PWM) mode, configured in accordance with one embodiment of the present invention.

FIG. 10 illustrates a graphical depiction of DC operation of the controller of FIG. 3 at light load (50 mA) in pulse frequency modulation (PFM) mode, configured in accordance with one embodiment of the present invention.

FIG. 11A illustrates a graphical depiction of operating waveforms of the controller embodiment of FIG. 3 during a load transient, configured in accordance with one embodiment of the present invention.

FIG. 11B illustrates a graphical depiction of a zoomed waveform of FIG. 11A when controller changes from PWM to PFM mode due to a load current decrease, configured in accordance with one embodiment of the present invention.

FIG. 11C illustrates a graphical depiction of a zoomed waveform of FIG. 11A when controller changes from PFM to PWM mode due to a load current suddenly increasing, configured in accordance with one embodiment of the present invention.

FIG. 12 illustrates a graphical depiction of an efficiency comparison between the controller of FIG. 3 and a traditional synchronous controller configured in accordance with one embodiment of the present invention.

FIG. 13 illustrates a graphical depiction of measured frequency versus output current with hysteresis for the controller of FIG. 3 and graph of FIG. 7, configured in accordance with one embodiment of the present invention.

FIG. 14 illustrates a graphical depiction of a step response of the controller of FIG. 3 with hysteresis shown in FIG. 7, configured in accordance with one embodiment of the present invention.

FIG. 15 illustrates a graphical depiction of a step response of a controller without the hysteresis shown in FIG. 7 and the FIG. 3 controller without hysteresis added in, configured in accordance with one embodiment of the present invention.

FIG. 16 illustrates graphical depictions of simulated overshoot without and with oscillator feed-forward, configured in accordance with one embodiment of the present invention.

FIG. 17 illustrates a graphical depiction of a step response V_{IN} for one example of a controller in FIG. 3 with feed-forward, configured in accordance with one embodiment of the present invention.

FIG. 18A is a block diagram illustrating an embodiment of the controller with unit gain application where Vₒᵤₜ=V_{P} configured in accordance with one embodiment of the present invention.

FIG. 18B is a block diagram illustrating an embodiment of the controller with unit gain application where Vₒᵤₜ=(Fixed Gain)×V_{P} configured in accordance with one embodiment of the present invention.

FIG. 19 is a block diagram illustrating a voltage mode PWMFF_PFM controller with error amplifier limit block, configured in accordance with one embodiment of the present invention.

FIG. 20 is a diagram illustrating a mode selection logic state diagram for a voltage mode PWMFF_PFM controller with error amplifier limit block, configured in accordance with one embodiment of the present invention.

FIG. 21A illustrates a graphical depiction of waveforms for the voltage mode PWMFF_PFM controller with error amplifier limit block of FIG. 19, configured in accordance with one embodiment of the present invention.

FIG. 21B illustrates a graphical depiction of zoomed waveforms of FIG. 21A.

FIG. 22 illustrates a graphical depiction of the efficiency of the PWMFF_PFM controller of FIG. 19 with error amplifier (EA) limit V_{IN}=12, and V_{OUT}=5V configured in accordance with one embodiment of the present invention.

FIG. 23 is a block diagram illustrating an embodiment of a voltage mode PWMFF_SKIP combo controller, configured in accordance with one embodiment of the present invention.

FIG. 24 is a diagram illustrating a state diagram of mode selection logic for a voltage mode PWMFF_SKIP controller, configured in accordance with one embodiment of the present invention.

FIG. 25A illustrates a graphical depiction of PWMFF_SKIP mode operation of the controller of FIG. 23 with a light load, configured in accordance with one embodiment of the present invention.

FIG. 25B illustrates a graphical depiction of zoomed waveforms of FIG. 25A, configured in accordance with one embodiment of the present invention.

FIG. 26 illustrates a graphical depiction of voltage mode PWMFF_SKIP mode operation of the controller of FIG. 23 with transient load current configured in accordance with one embodiment of the present invention.

### DETAILED DESCRIPTIONS

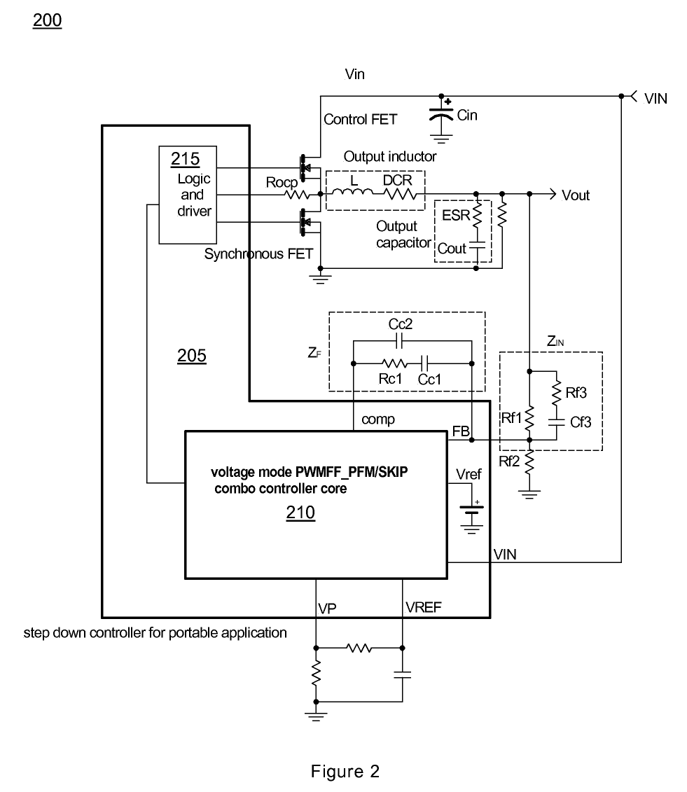

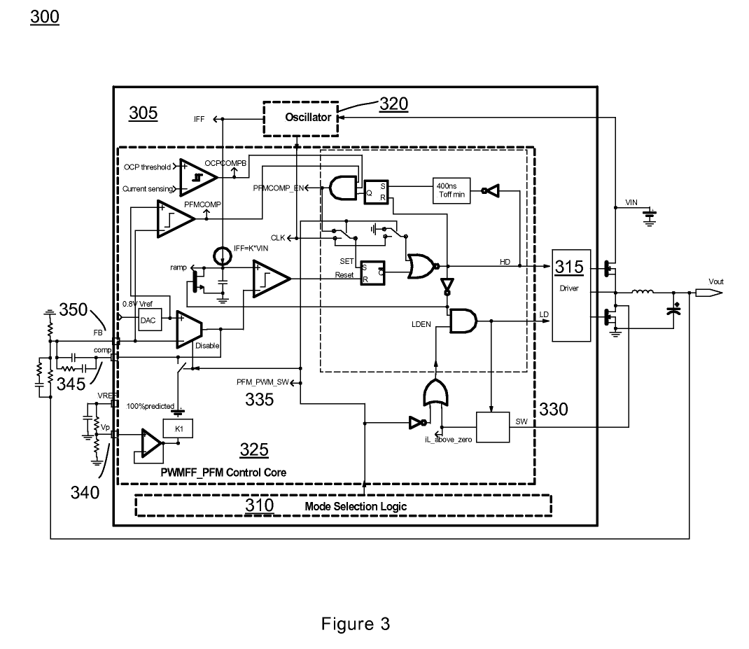

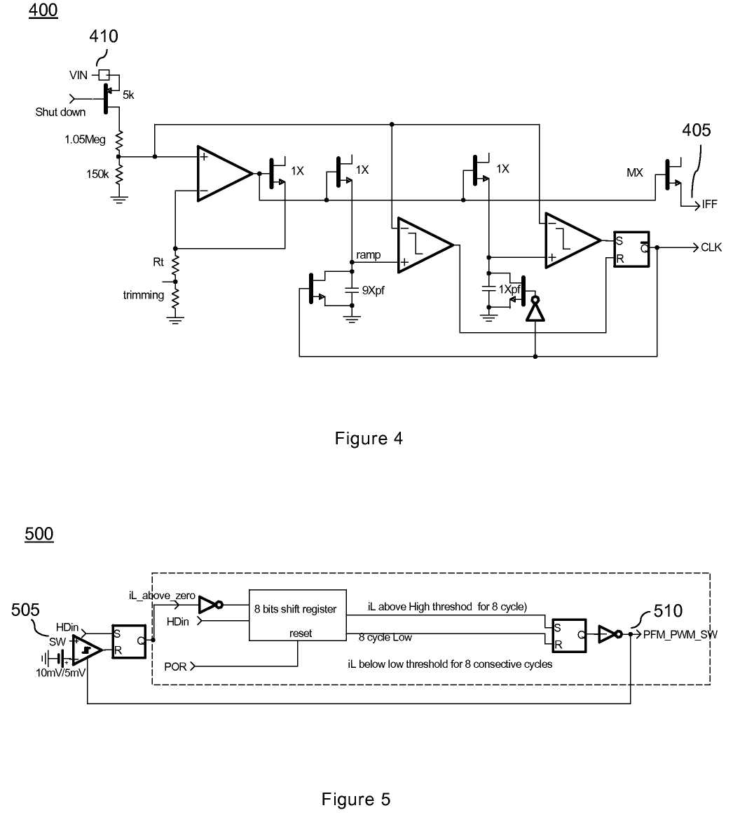

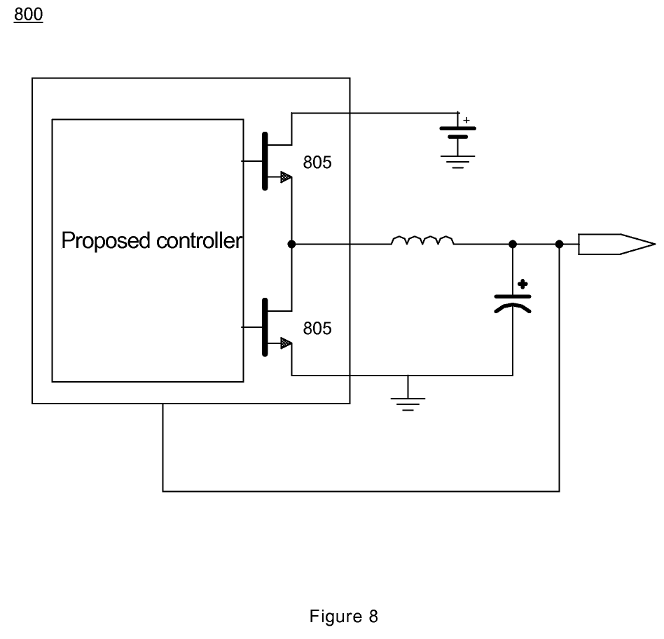

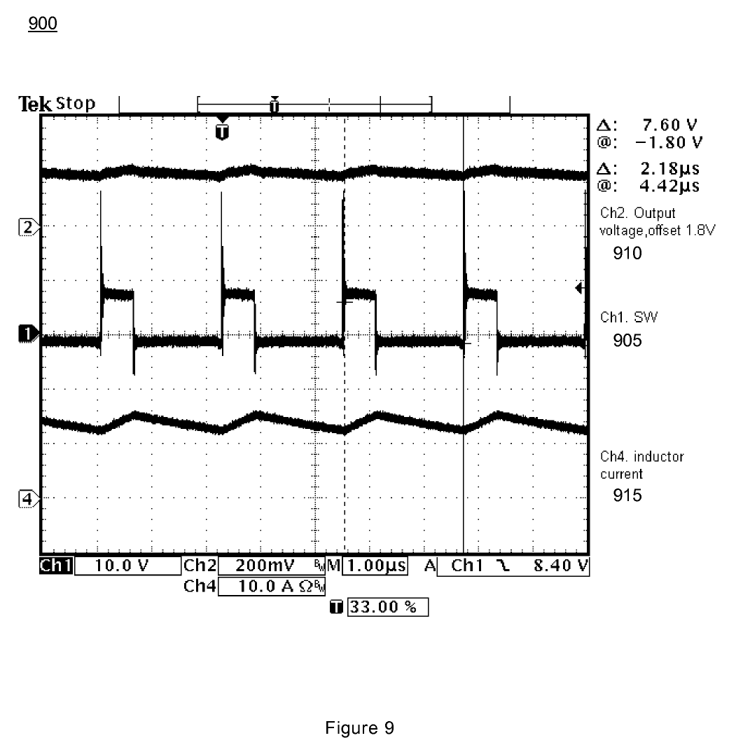

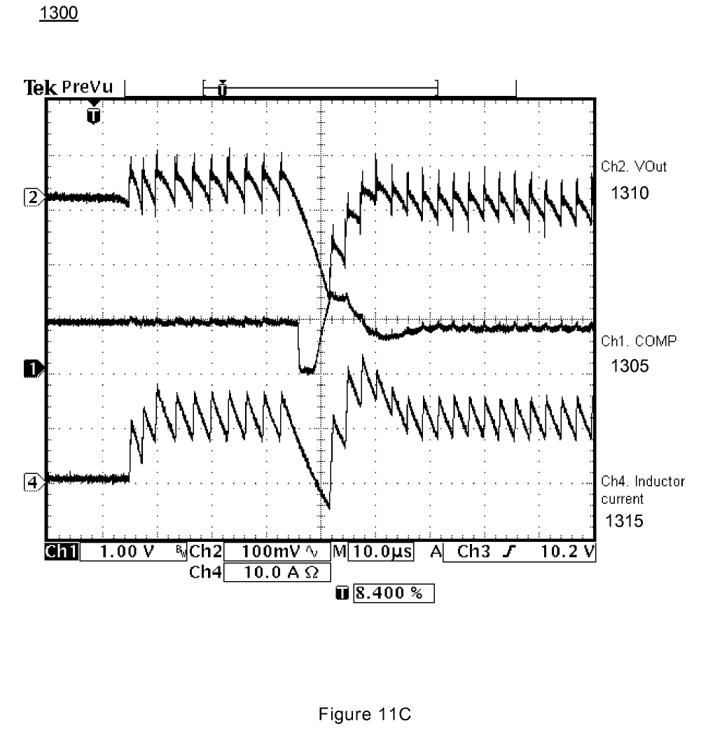

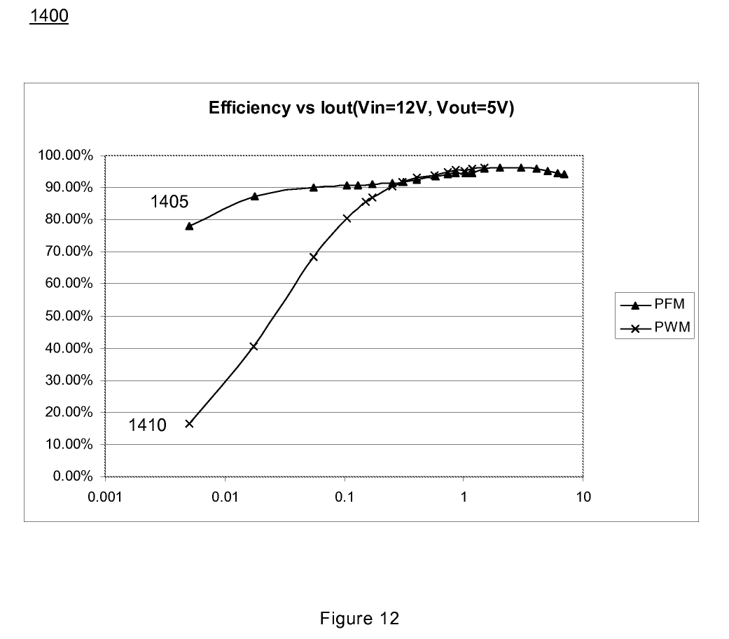

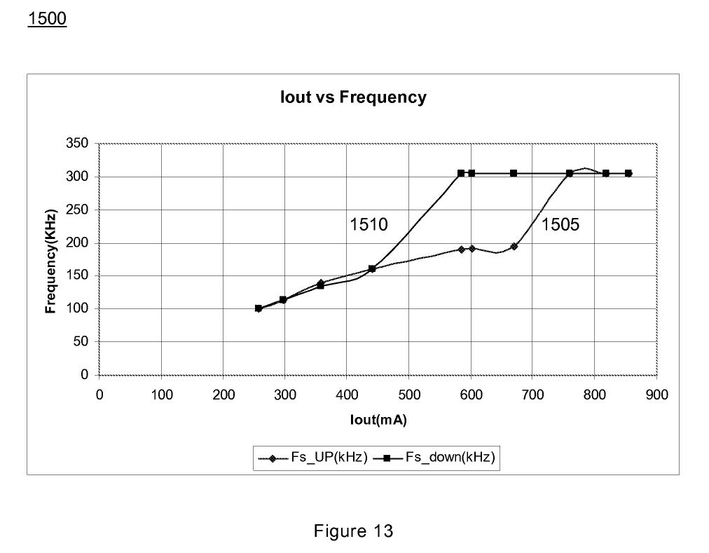

Circuit figures portray embodiments of the invention shown in systems and components of the invention. Features of embodiments include integrated MOSFET components, hysteresis, oscillator feed-forward, fixed gain, error amplifier (EA) limits, and SKIP mode operation. Particularly, FIG. 2 displays an embodiment of the invention in a portable system and FIG. 3 displays more detail of a combo controller core shown in FIG. 2. FIG. 4 displays more detail of an oscillator shown in FIG. 3, and FIG. 5 displays more detail of mode selection logic shown in FIG. 3. FIG. 8 is an embodiment of the controller shown in FIG. 3 with added, integrated, MOSFET components. Figures that include oscilloscope displays primarily portray operation of embodiments of the invention. Again, particularly, FIGS. 9 through 11C display waveforms from the embodiment of FIG. 3. FIGS. 11A-11C portray operation of embodiments of FIG. 3 during a load transient. FIGS. 12 and 13 are graphs of measured data.

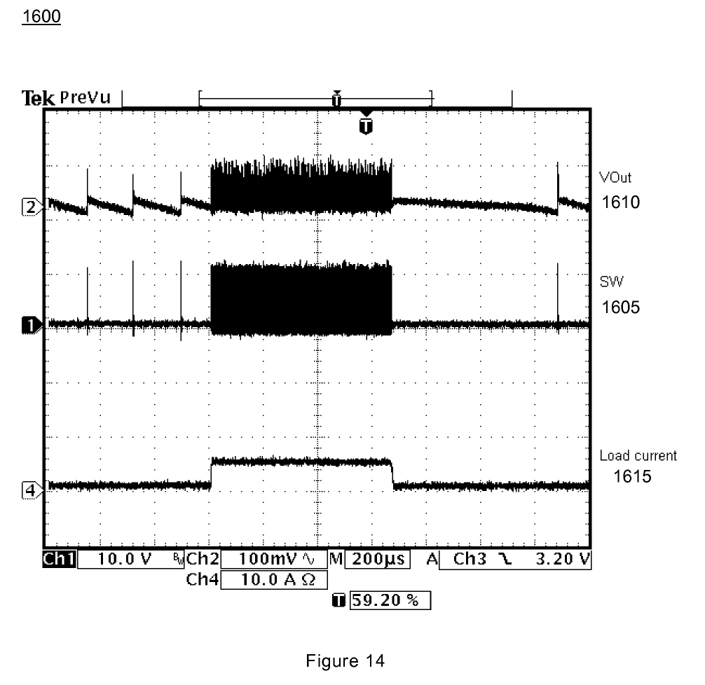

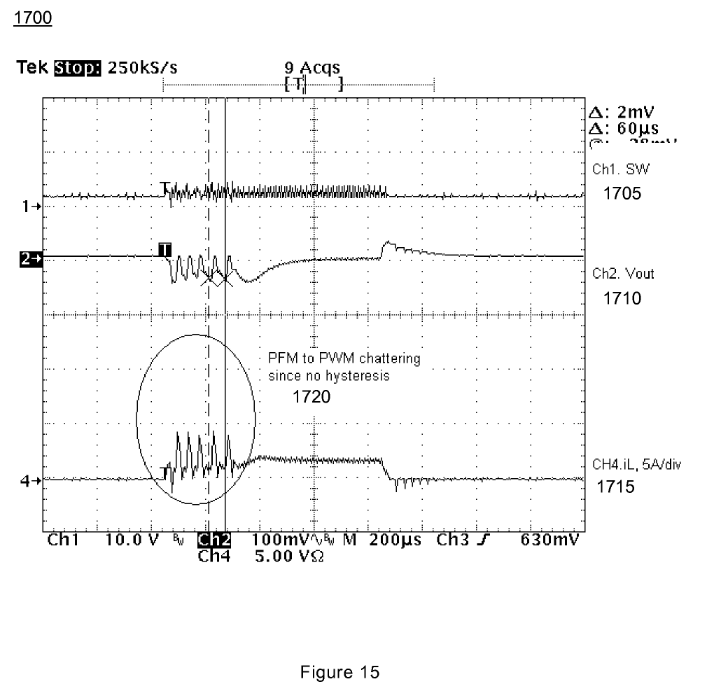

FIGS. 14 and 15 are oscilloscope displays portraying operation of embodiments demonstrating the effects of hysteresis.

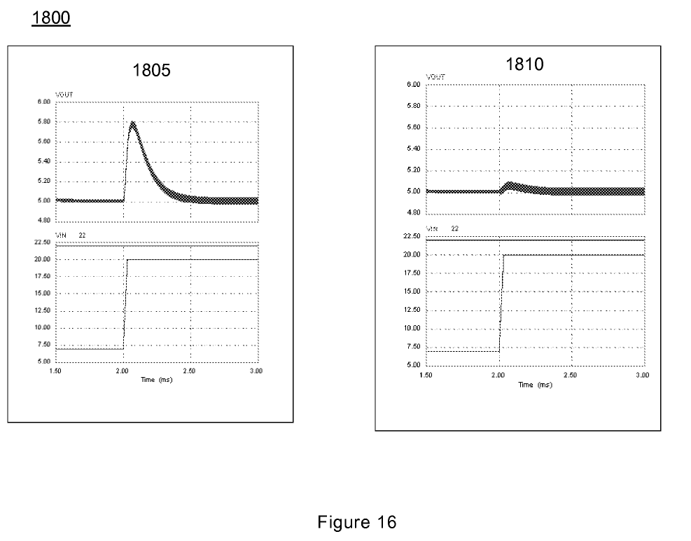

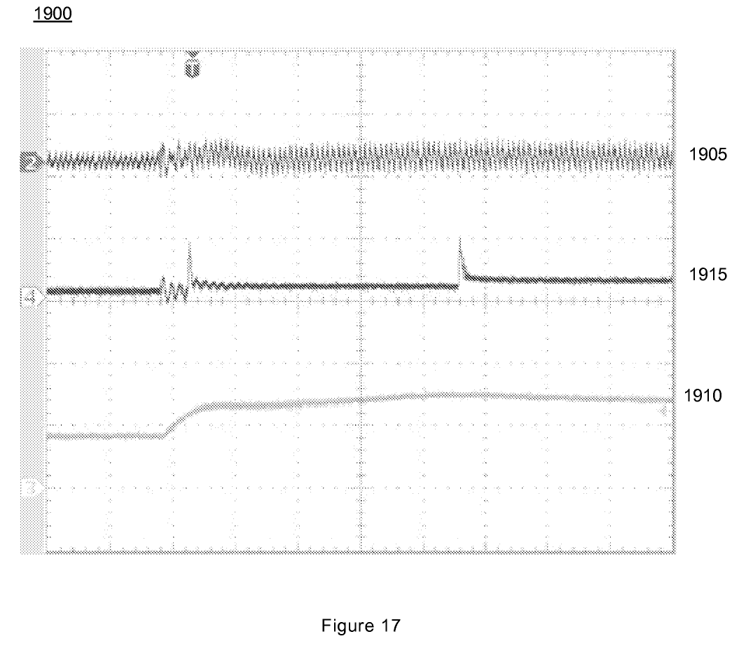

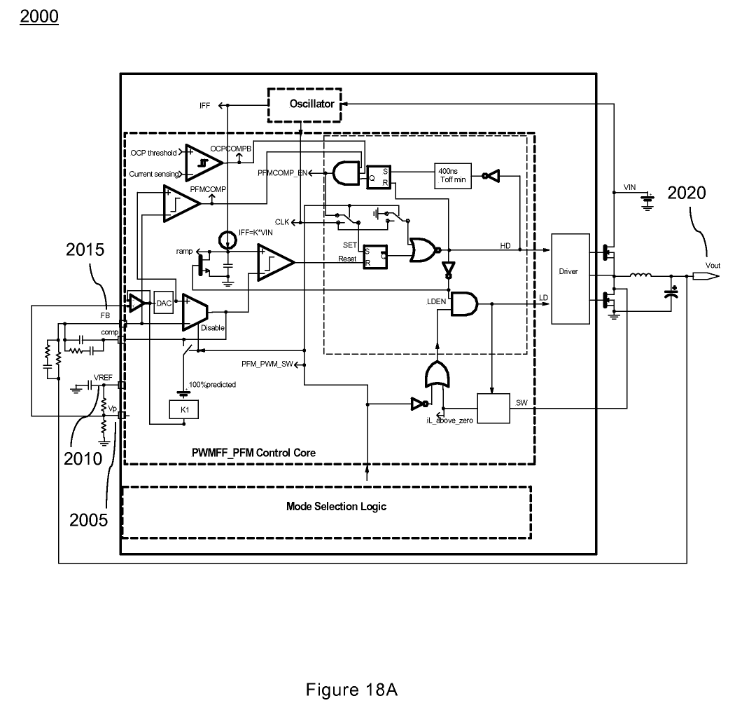

FIGS. 16 and 17 demonstrate simulated and measured effects of oscillator feed-forward.

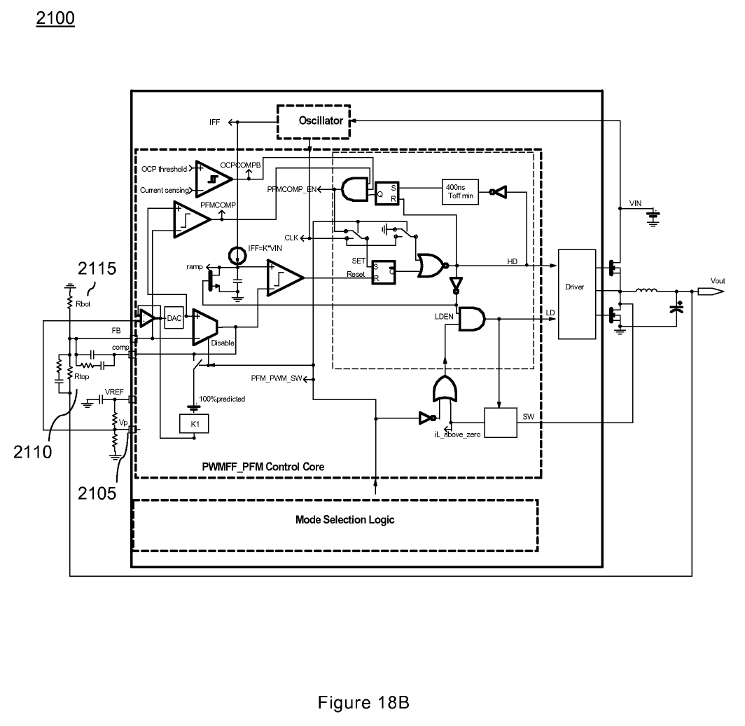

FIGS. 18A and 18B are circuit figures of embodiments of the invention including fixed gain configurations.

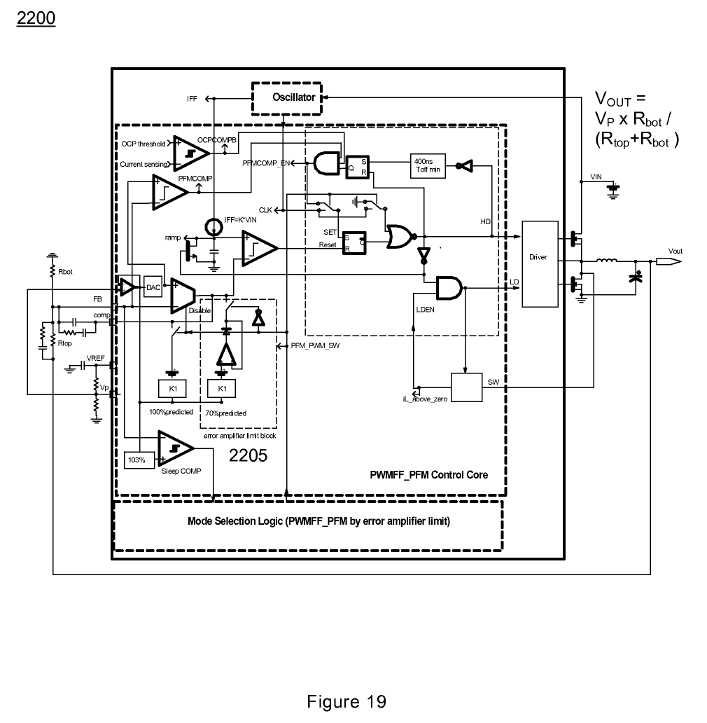

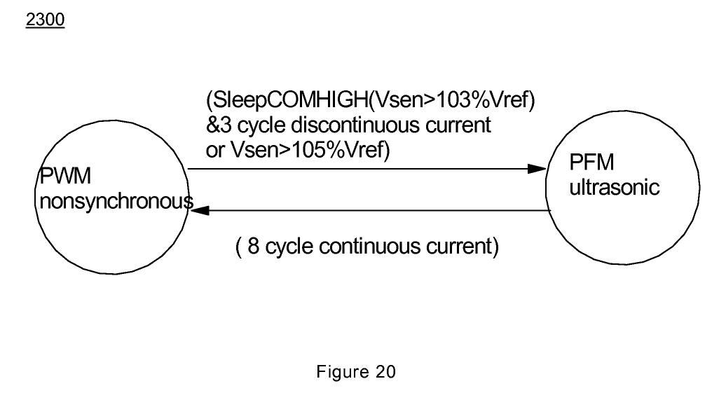

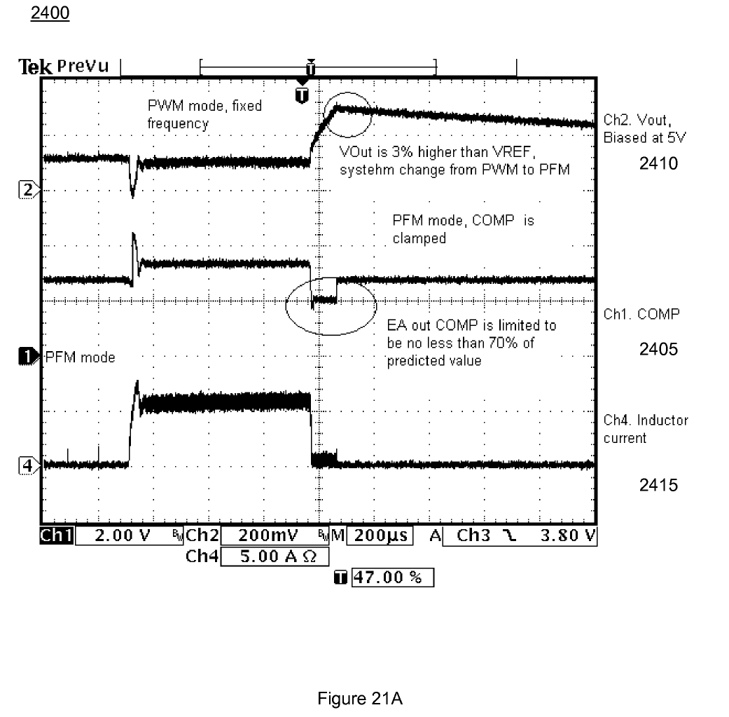

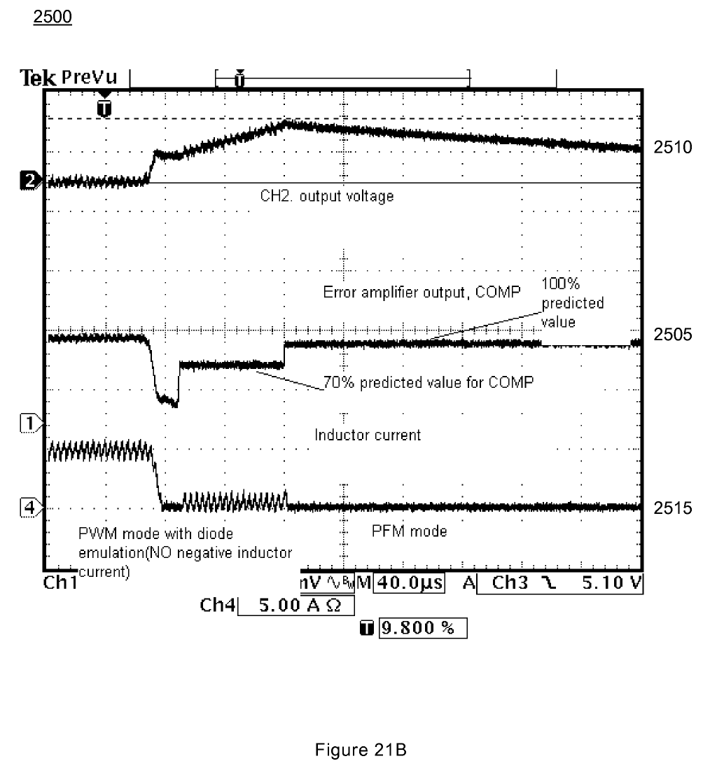

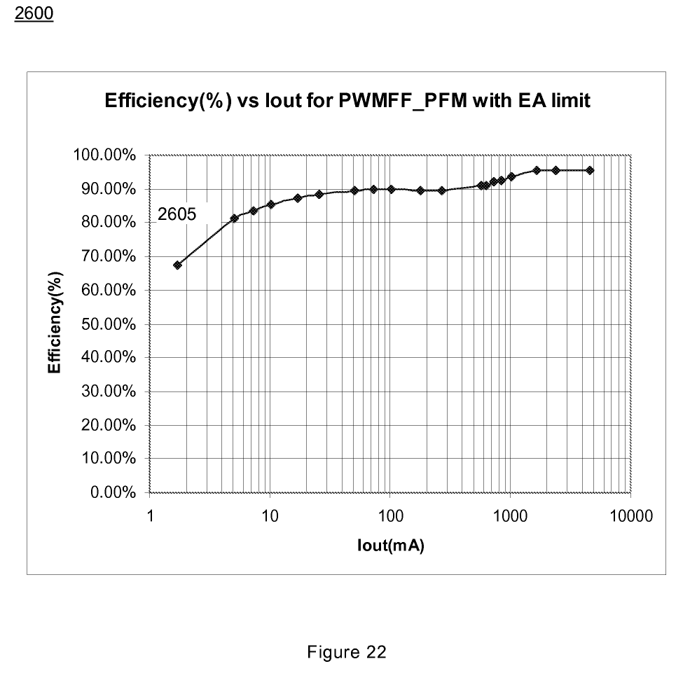

FIGS. 19 and 20 are circuit and logic figures portraying an embodiment of the invention including error amplifier (EA) limits. FIGS. 21A and 21B and 22 are oscilloscope and efficiency displays from the EA embodiments of FIG. 19.

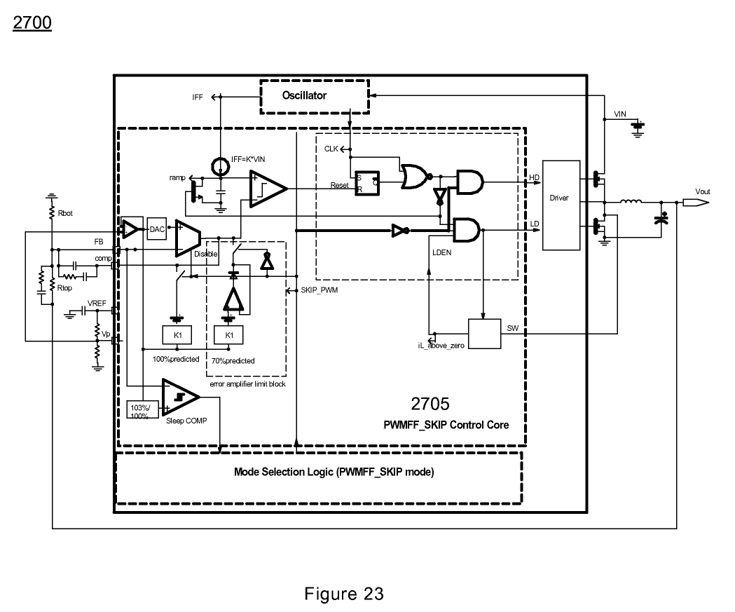

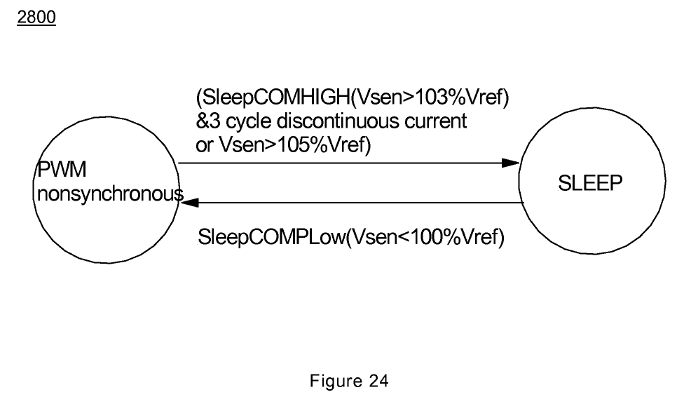

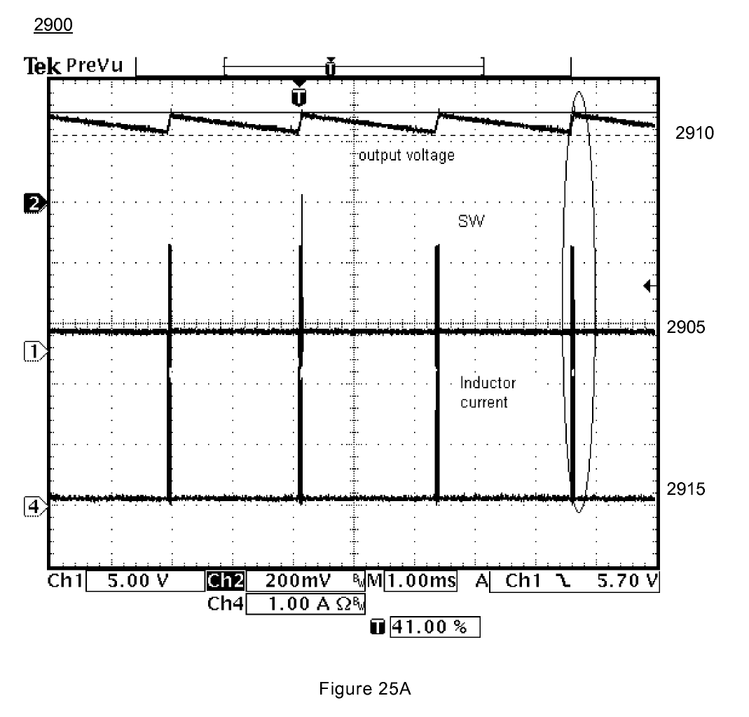

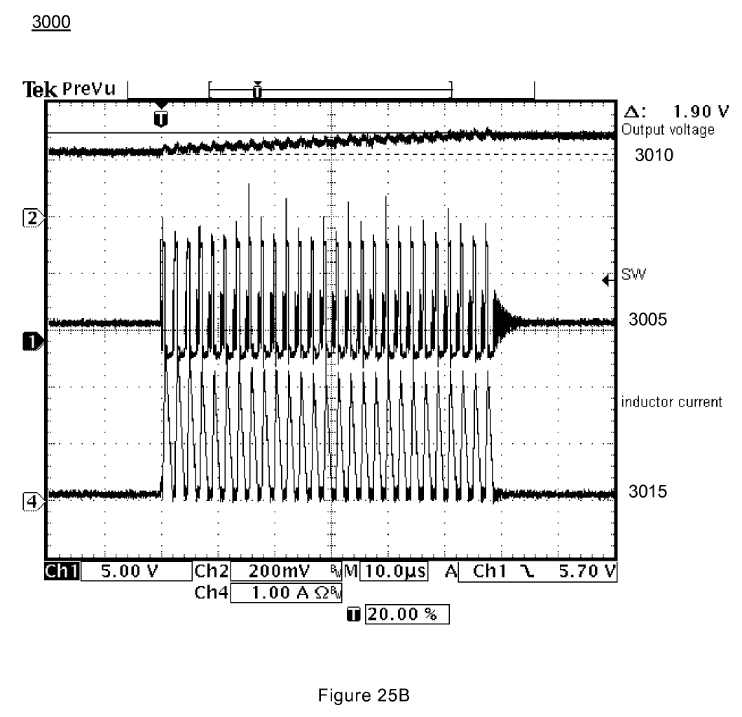

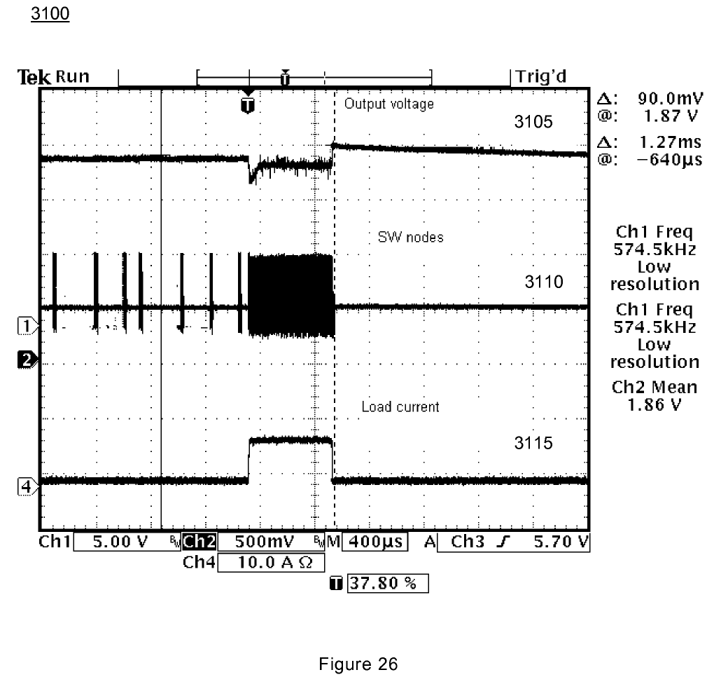

FIGS. 23 and 24 are circuit and logic figures portraying an embodiment of the invention including SKIP mode. FIGS. 25A and 25B and 26 are oscilloscope displays from the SKIP mode embodiments of FIG. 23.

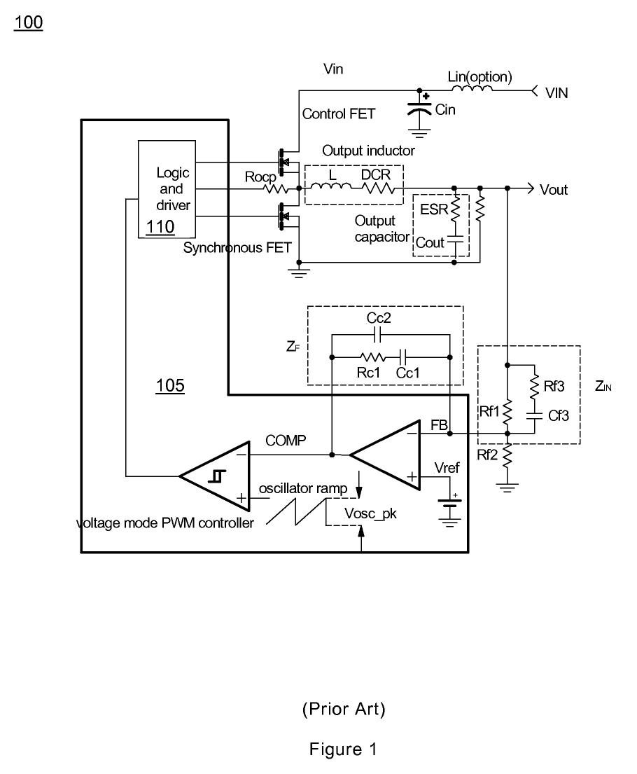

Now, particularly referring to each figure, FIG. 1 is a simplified prior art block diagram 100 illustrating a traditional voltage mode PWM controller for synchronous buck applications. It includes a voltage mode PWM controller 105 and logic and driver component 110.

FIG. 2 is a simplified block diagram 200 illustrating an embodiment of a PWMFF_PFM combo controller suitable for portable applications that overcomes the limitations of the traditional voltage mode PWM controller of FIG. 1. Controller 205 comprises within it controller core 210 and logic and driver 215.

FIG. 3 is a simplified block diagram 300 providing more detail of the controller 205 of FIG. 2. Controller 305 includes PWMFF_PFM control core 325, mode selection logic 310, logic and driver 315, and oscillator 320. Mode selection logic is used to determine the operation mode (PWM or PFM) based on the information at SW node 330 since the SW node voltage is equal to the output inductor current times the resistance of the low side MOSFET when the low side driver is on. As a result, the SW node contains the information of output current. The hysteresis is built in to the comparator (505 in FIG. 5), which monitors the SW voltage when the low side MOSFET is ON. “PWM_PFM_SW” 335 is a signal to indicate in which mode the controller is operating (HI for PWM and LO for PFM). This signal is also used to set the hysteresis for COMP in 505 of FIG. 5. In this case, when PWM_PFM_SW=HI (PWM mode), the hysteresis is 5 mV and it is 10 mV for PFM Mode. The voltage at pin “VP” 340 is used to indicate the output voltage. COMP pin 345 is the output of the error amplifier and together with FB 350 is used to compensate the voltage control feedback loop.

FIG. 4 is a diagram 400 of an oscillator block providing more detail of an oscillator 320 of FIG. 3. The feed-forward oscillator is designed such that the oscillator ramp as well as the current source “I_{FF}” 405 to the PWM COMP is proportional to V_{IN} 410. The frequency is maintained constant regardless of how V_{IN} 410 changes. This oscillator architecture improves the step response of V_{IN} 410 and makes the system bandwidth independent of V_{IN} 410.

FIG. 5 is a simplified block diagram 500 of an embodiment of mode selection logic providing more detail for Mode Selection Logic 310 of FIG. 3. It switches between PWM and PFM modes and includes add in hysteresis. At light load, the controller senses at 505 the output current through “SW” nodes of the controller, 330 of FIG. 3. If the inductor current is below a certain low threshold for a certain time, e.g. 8 cycles of clock, the controller will switch over to PFM mode. At heavy load, if the controller senses that the output current is higher than the high threshold for a certain time, such as 8 consecutive cycles, then the controller switches from PFM to PWM. The difference between these two thresholds is set by signal “PFM_PWM_SW” 510 (corresponding to 335 in FIG. 3) which will generate a hysteresis between the two modes. Additional explanation is included in the hysteresis description of FIG. 7.

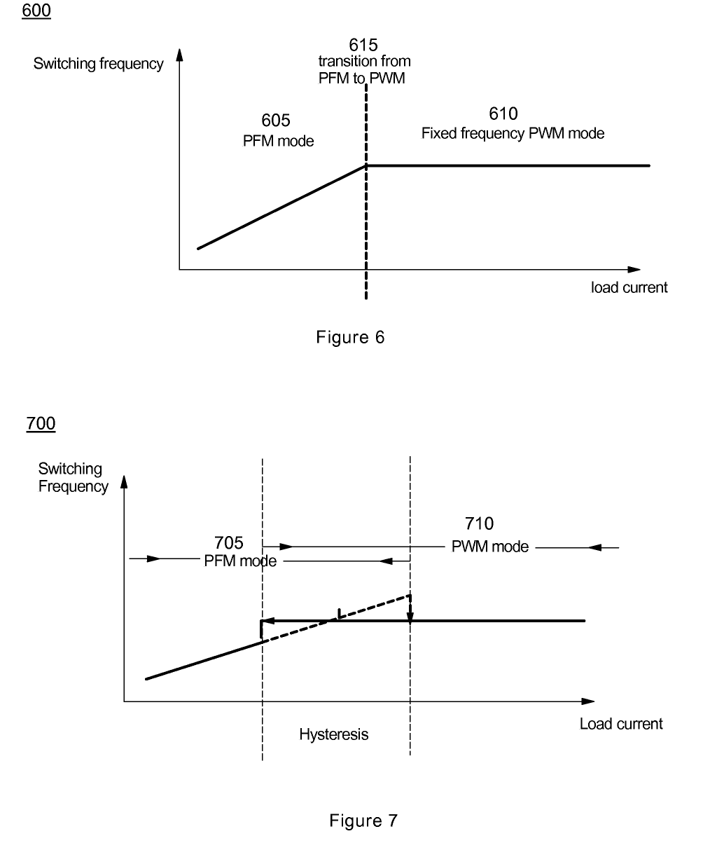

FIG. 6 is a graph 600 showing switching frequency versus load current for an embodiment of the controller in an ideal case. At light load, the controller operates in PFM mode 605 and switching frequency is reduced as load current decreases. At high current, the switching frequency is fixed and the controller operates in fixed frequency PWM mode 610. In practice, certain hysteresis is employed to reduce jitter during the PFM-PWM transition 615.

FIG. 7 is a graph 700 showing switching frequency versus load current for an embodiment of the controller including hysteresis. An implementation is shown in the mode selection logic of FIG. 5. When the controller switches from PWM mode 705 to PFM mode 710, the error amplifier (EA) output is clamped to a calculated or predicted value based on V_{IN} and “V_{P}” voltages. Voltage at pin “VP” (340 of FIG. 3) is used to indicate the output voltage. For example, if Vₚ voltage is defined at half of the output voltage, it can be set by V_{REF}, e.g. 3V, by a resistor divider. Based on Vₚ and V_{IN} voltage, the predicted COMP voltage is calculated and clamped during PFM mode 705. The maximum output voltage at this mode is dependent on V_{REF} voltage. For example, if V_{REF} is 3V and V_{P} is set to half of V_{OUT}, then the maximum V_{OUT} is about two times V_{REF} or 6V. This embodiment of the PWMFF_PFM controller can employ most types of output capacitors except ceramic capacitors. For ceramic capacitors, either a resistor is used in series with the capacitor, or the PWMFF_SKIP mode controller as shown in FIG. 23 may be used.

FIG. 8 is a simplified block diagram 800 of an embodiment of the controller in an application with monolithic power (integrated controller and MOSFETs 805). As shown, embodiments of the invention are not limited to a controller plus external MOSFET applications; they can also be applied to integrated solutions of a controller with integrated MOSFET.

FIGS. 9 through 13 display waveforms from the embodiment of FIG. 3.

FIG. 9 depicts waveforms 900 of DC operation of the circuit of FIG. 3 at a 10 amp load in PWM mode. Channel 1 905, represents signal SW with a scale of 10.0 volts per division. Channel 2 910, represents the output voltage, offset by 1.8 volts. Channel 4 915, represents the inductor current with a scale of 10.0 amps per division.

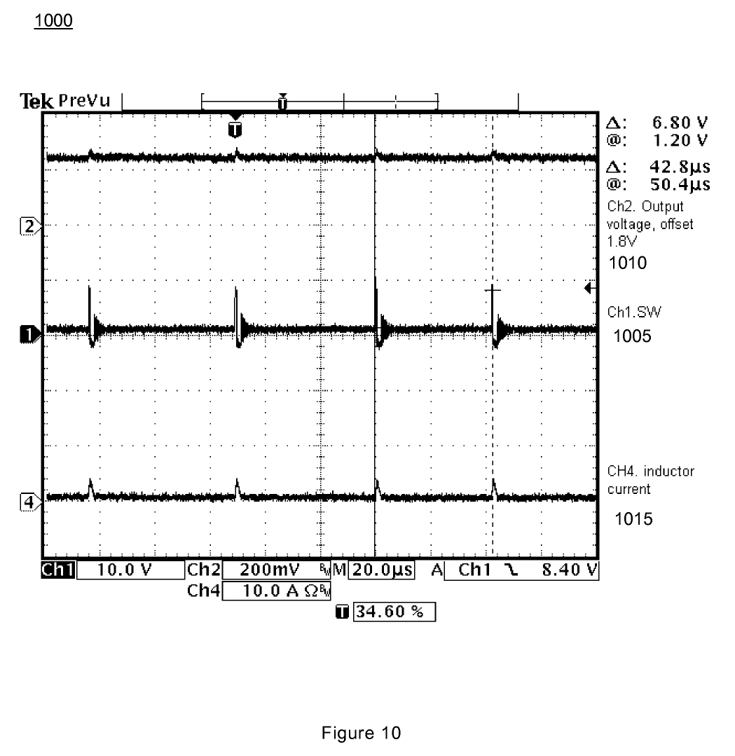

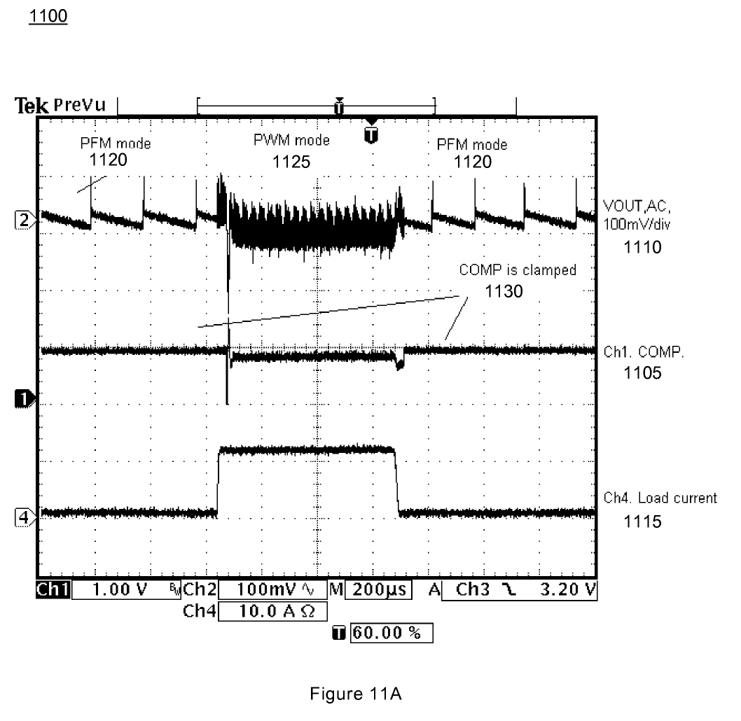

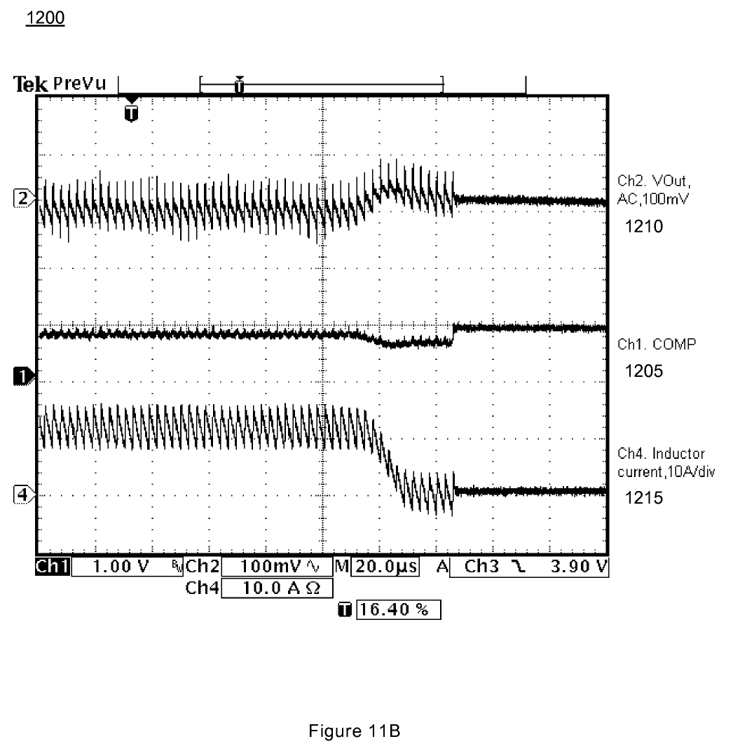

FIG. 10 depicts waveforms 1000 of DC operation of the circuit of FIG. 3 at light load (50 mA) in PFM mode. Similar to FIG. 9, channel 1 1005, represents the SW signal with a scale of 10.0 volts per division. Channel 2 1010, represents the output voltage, offset by 1.8 volts. Channel 4 1015, represents the inductor current with a scale of 10.0 amps per division.

FIG. 11A depicts operating waveforms 1100 during a load transient. It shows a transient response for the controller in FIG. 3 with hysteresis built-in. Channel 2 1110 is the AC output voltage. Channel 1 1105 is the error amplifier output, which corresponds to the COMP pin. Channel 4 1115 is load current. Several features can be observed. At light load, the circuit operates in PFM mode 1120 with the switching frequency reduced. Results can be seen in the output ripple shown in FIG. 10. At high current, the circuit operates in voltage PWM mode 1125 with fixed frequency as shown in FIG. 9. At PFM mode, the error amplifier COMP is clamped 1130 to a predicted value, which is very close to the operating voltage in PWM mode. This significantly reduces the voltage droop during the transition and provides a smooth transition.

FIGS. 11B and 11C show the transition between PFM to PWM and PWM to PFM. During the transition, the overshoot and undershoot are minimized with the clamped error amplifier output along with the mode-selection-logic as shown in FIG. 5.

FIG. 11B depicts zoomed waveforms 1200 of FIG. 11A when controller changes from PWM to PFM mode due to load current decrease. Channel 2 1210 is the AC output voltage. As in FIG. 11A, channel 1 1205 is the error amplifier output, which corresponds to the COMP pin. Channel 4 1215 is inductor current.

FIG. 11C similarly depicts zoomed waveforms 1300 of FIG. 11A when controller changes from PFM to PWM mode due to a load current sudden increase. As before, channel 2 1310 is the AC output voltage. Channel 1 1305 is the error amplifier output, which corresponds to the COMP pin. Channel 4 1315 is load current.

FIG. 12 graph 1400 shows a measured efficiency comparison between the efficiency 1405 of one embodiment of the invention and traditional synchronous controller efficiency 1410. An aspect of the invention is that the light-load efficiency exceeds a traditional PWM controller's. This can extend battery operating time for portable applications. At heavy load, the efficiency is same as a traditional PWM controller, which maintains thermal performance of the synchronous converter.

FIG. 13 shows a graph 1500 of the measured frequency versus output current for one example of a controller. The hysteresis in the curve is added to prevent chattering between PFM and PWM mode, as shown in FIGS. 14 and 15. Curve 1505 shows load current going up (labeled Fs_down) and curve 1510 shows load current going down (labeled Fs_UP).

FIG. 14 depicts operating waveforms 1600 for a step response of an embodiment of the controller with hysteresis. Channel 1 1605, represents the SW signal with a scale of 10.0 volts per division. Channel 2 1610, represents the output voltage, V_{OUT}. Channel 4 1615, represents the load current with a scale of 10.0 amps per division.

FIG. 15 depicts operating waveforms 1700 for a step response of a controller without hysteresis. As in FIG. 14, channel 1 1705, represents the SW signal with a scale of 10.0 volts per division. Channel 2 1710, represents the output voltage, V_{OUT}. Channel 4 1715, represents the load current with a scale of 5 amps per division. Chattering 1720 is evident without hysteresis.

FIGS. 16 and 17 show the V_{IN} step response for an example of a controller with feed-forward. The oscillator with feed-forward function exhibits a step response better than traditional PWM controllers.

FIG. 16 illustrates graphical depictions 1800 of simulated overshoot of V_{IN} step response between a traditional PWM controller without feed-forward and a controller embodiment with a feed-forward oscillator. Overshoot is shown for a simulated increase of V_{IN} from 7 volts to 20 volts in 30 microseconds. Graph 1805 without feed-forward shows an 800 millivolt overshoot. Graph 1810 with feed-forward shows a 50 millivolt overshoot.

FIG. 17 depicts operating waveforms 1900 for a step response of V_{IN} for an embodiment of the controller with a feed-forward oscillator as in FIG. 4. Channel 2 1905 shows the AC component of V_{OUT}, with a scale of 100 mV per division. Channel 3 1910 represents V_{IN} changes from 8 to 16 volts. Channel 4 1915 represents the SW signal.

FIGS. 18A and 18B are simplified diagrams 2000 and 2100 depicting the embodiment of FIG. 3 including a system with unit gain or fixed gain. The noninv or positive input of the error amplifier is set by V_{P} through a unit gain buffer. In this application, output voltage will be equal to
V_{OUT}=V_{P} for FIG. 18A.
For FIG. 18B:

$${V}_{OUT} = {V}_{P} \times \frac{{R}_{bot}}{{R}_{top} + {R}_{bot}} ( ratio of {R}_{top} {R}_{bot} is fixed for given controller )$$

For FIG. 18A, the output voltage is mainly changed by the V_{P} 2005 voltage through a resistor divider and V_{REF} 2010. At normal operation, the FB 2015 voltage of the error amplifier will be regulated to the output voltage. Since the V_{P} 2005 voltage will be equal to V_{OUT} 2020 or a fixed ratio of V_{OUT} 2020, the controller knows what the input and output voltages are and it can clamp the error amplifier output to the predicted value during pulse frequency mode (PFM). In this case, the transition from PFM to PWM can be smooth with low undershoot.

For FIG. 18B, the output voltage is set to be fixed gain of voltage at VP 2105, which can enlarge the application with higher output voltage than VP 2105. Where the ratio of Rₜₒₚ 2110 R_{bot} 2115 is fixed for a given controller.

FIG. 19 shows a simplified block diagram 2200 of an embodiment of a PWMFF_PFM controller with an error amplifier limit block 2205. In the circuit of this diagram, (1) the error amplifier output is limited to be no smaller than 70% of the predicted output voltage. (2) The low side driver is turned off once inductor current is below zero. In this case, the step down controller can not sink current in PWM mode. The waveform is shown in FIGS. 21A and 21B. The efficiency is shown in FIG. 22. The efficiency is above 80% for load current as low as 5 mA. At 1 mA, the efficiency is above 65%.

FIG. 20 is a mode selection logic state diagram 2300 for a voltage mode PWMFF_PFM controller with an error amplifier limit block as in FIG. 19. The PWM (nonsynchronous) mode switches to PFM (ultrasonic) mode when either V_{SEN} is more than 103% of V_{REF} for 3 cycles, or V_{SEN} is more than 105% of V_{REF}. PFM mode switches back to PWM mode following 8 cycles of continuous current. V_{SEN} is sensed output voltage.

FIG. 21A depicts operating waveforms 2400 for a step response of an embodiment of the voltage mode PWMFF_PFM controller with error amplifier limit block of FIG. 19. Channel 1 2405, represents the COMP signal with a scale of 2.0 volts per division. Channel 2 2410, represents the output voltage, V_{OUT}. Channel 4 2415, represents the inductor current with a scale of 5.0 amps per division.

FIG. 21B depicts zoomed waveforms 2500 of FIG. 21A during a transient. Channel 1 2505, represents the COMP signal. Channel 2 2510, represents the output voltage, V_{OUT}. Channel 4 2515, represents the inductor current with a scale of 5.0 amps per division.

FIG. 22 depicts a graph 2600 of efficiency 2605 for the embodiment of the voltage mode PWMFF_PFM controller with error amplifier limit block of FIG. 19 with V_{IN}=12 and V_{OUT}=5V.

FIG. 23 shows an embodiment 2700 of a voltage mode PWMFF_SKIP controller. One advantage of the PWMFF_SKIP controller with PWMFF_SKIP controller core 2705 is its stability with ceramic output capacitors. Differences between PWMFF_PFM controller and PWMFF_SKIP controller embodiments are shown in Table 1. Operational waveforms are shown in FIGS. 25A, 25B, and 26.

TABLE 1

| | Voltage mode | Voltage mode |
|---|---|---|
| Parameter | PWMFF_PFM mode | PWMFF_SKIP |
| Operation at high | Fixed frequency | Fixed frequency |
| current | PWM. | PWM. |
| Operation at light load | PFM mode (pulse | SKIP mode. |
| | frequency mode). | |
| Output voltage ripple | Low | High |
| DC Operation cycles in | One or two cycles with | A couple consecutive |
| each pulse at light load | pre-fixed on time | fixed frequency PWM |
| | pulse. | cycles. |
| Efficiency at PWM | High and same as | High and same as |
| mode | traditional PWM | traditional PWM |
| | controller. | controller. |
| Efficiency at light load | Higher than traditional | Higher than traditional |
| | PWM controller. | PWM controller. |
| Output capacitor with | Electrolytic capacitor | All capacitors |
| stable operation | or POSCAPs. | including ceramic |
| | | capacitors. |

Table 1 Presents general comparisons between PWMFF_PFM mode and PWMFF_SKIP mode for two embodiments of a controller.

FIG. 24 depicts a state diagram of mode selection logic 2800 for an embodiment of the voltage mode PWMFF_SKIP controller FIG. 25. The PWM (nonsynchronous) mode switches to sleep mode when either V_{SEN} is more than 103% of VREF for 3 cycles, or V_{SEN} is more than 105% of V_{REF}. Sleep mode switches back to PWM mode when V_{SEN} is less than 100% of V_{REF}. VSEN is the sensed output voltage.

FIG. 25A depicts operating waveforms 2900 for PWMFF_SKIP Mode operation with light load of FIG. 23. Channel 1 2905, represents SW, channel 2 2910, represents the output voltage, channel 4 2915, represents the inductor current.

FIG. 25B depicts zoomed waveforms 3000 of FIG. 25A. Channel 1 3005, represents SW, channel 2 3010, represents the output voltage, and channel 4 3015 represents the inductor current.

FIG. 26 depicts waveforms 3100 of Voltage mode PWMFF_SKIP mode operation with transient load current. Channel 1 3005, represents output voltage, channel 2 3010, represents SW, and channel 4 3015, represents load current.

The invention is susceptible of numerous other embodiments. For example, there is a pulse width modulation (PWM), pulse frequency modulation (PFM) controller circuit that has a control core; an oscillator having an input voltage and being electrically connected to the control core; with mode selection logic electrically connected to the control core; and driver logic electrically connected to the control core. The oscillator may be configured as feed-forward, wherein the ramp of the oscillator is proportional to the input voltage. The mode selection logic may include hysteresis.

The control core may have an error amplifier limit. The output of the error amplifier may be limited to at least 70 percent of predicted output voltage.

The control core may have an error amplifier wherein the error amplifier input gain is fixed. Alternatively, the control core may have an error amplifier having an adjustable input gain. The output of the error amplifier may clamp to a predicted value from a reference voltage and a resistor divider. Other embodiments may have a skip mode.

As another example of the invention, there is a voltage mode pulse width modulation, pulse frequency modulation, skip mode controller, that has at least one switching section; a combo control core coupled to the switching section, where said combo control core consists of a control core section, an oscillator section having an input voltage and being electrically connected to the control core section, a mode selection logic section electrically connected to the control core section; and a driver logic section electrically connected to the control core section. The control core section may have an error amplifier with a clamped output. The mode selection logic section may be configured with hysteresis. The oscillator section may be configured as feed-forward. This or other embodiments may further consist of at least one integrated controller Metal-Oxide-Semiconductor Field-Effect Transistor (MOSFET).

As yet another example of the invention, there is a method for controlling a buck converter consisting of the steps of: sensing an output current by monitoring a low side switch voltage when the low side switch is on; comparing the sensed output current to a threshold to determine an operational mode; entering a pulse frequency mode when the sensed output current is below the threshold; and entering a pulse width mode when the sensed output current is above the threshold.

The step of comparing may consider hysteresis wherein the threshold consists of a high threshold and a low threshold. The step of comparing may further include comparing the sensed output current to a threshold for a predetermined time. The step of entering a pulse frequency mode may further include setting switching frequency based on a predicted value. The pulse width mode may consist of a skip mode. The method may be further configured as feed-forward.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A pulse width modulation (PWM), pulse frequency modulation (PFM) controller circuit comprising:
a control core;
an oscillator having an input voltage, electrically connected to said control core;
mode selection logic electrically connected to said control core; and
driver logic electrically connected to said control core.

2. The circuit according to claim 1, wherein said oscillator compromises feed-forward, wherein ramp of said oscillator is proportional to said input voltage.

3. The circuit according to claim 1, wherein said mode selection logic comprises hysteresis.

4. The circuit according to claim 1, wherein said control core comprises an error amplifier limit.

5. The circuit according to claim 4, wherein output of said error amplifier is limited to at least 70 percent of predicted output voltage.

6. The circuit according to claim 1, wherein said control core comprises an error amplifier wherein said error amplifier input gain is fixed.

7. The circuit according to claim 1, wherein said control core comprises an error amplifier having an adjustable input gain.

8. The circuit according to claim 7, wherein output of said error amplifier clamps to a predicted value from a reference voltage and a resistor divider.

9. The circuit according to claim 1, further comprising a skip mode.

10. A voltage mode pulse width modulation, pulse frequency modulation, skip mode controller, comprising:
at least one switching section;
a combo control core coupled to said switching section, said combo control core comprising:
a control core section;
an oscillator section having an input voltage, electrically connected to said control core section;
a mode selection logic section electrically connected to said control core section; and
a driver logic section electrically connected to said control core section.

11. The controller according to claim 10, wherein said control core section comprises an error amplifier with a clamped output.

12. The controller according to claim 10, wherein said mode selection logic section comprises hysteresis.

13. The controller according to claim 10, wherein said oscillator section comprises feed-forward.

14. The controller according to claim 10, further comprising at least one integrated controller Metal-Oxide-Semiconductor Field-Effect Transistor (MOSFET).

15. A method for controlling a buck converter comprising the steps of:
sensing an output current by monitoring a low side switch voltage when said low side switch is on;
comparing said sensed output current to a threshold to determine an operational mode;
entering a pulse frequency mode when said sensed output current is below said threshold; and
entering a pulse width mode when said sensed output current is above said threshold.

16. The method according to claim 15, wherein said step of comparing comprises hysteresis wherein said threshold comprises a high threshold and a low threshold.

17. The method according to claim 15, wherein said step of comparing further comprises comparing said sensed output current to a threshold for a predetermined time.

18. The method according to claim 15, wherein said step of entering a pulse frequency mode further comprises setting switching frequency based on a predicted value.

19. The method according to claim 15, wherein said pulse width mode comprises skip mode.

20. The method according to claim 15, wherein said method further comprises feed-forward.
